(19) United States
(12) Patent Application Publication
(10) Pub. No.: US 2021/0055738 A1
(43) Pub. Date: Feb. 25, 2021

(54) SELF-PROPELLED ROBOT

(71) Applicant: PANASONIC INTELLECTUAL PROPERTY MANAGEMENT CO., LTD., Osaka (JP)

(72) Inventors: Mayumi KOMATSU, Kyoto (JP); Shingo SHIBUSAWA, Osaka (JP); Shuji INOUE, Okayama (JP)

(21) Appl. No.: 16/991,652

(22) Filed: Aug. 12, 2020

(30) Foreign Application Priority Data
Aug. 21, 2019 (JP) 2019-151532

(51) Int. Cl. G05D 1/02

(52) U.S. Cl. CPC G05D 1/0223

(57) ABSTRACT

A self-propelled robot includes: a force sensor for detecting a lateral force in a wheel axial direction of each of a left drive wheel and a right drive wheel when a main body travels straight; an acquisition unit that acquires left target speed and right target speed, respectively, for the left drive wheel and the right drive wheel; a correction amount calculation unit that calculates a left correction amount and a right correction amount for the left target speed and the right target speed, respectively, based on the corresponding lateral forces detected by the force sensor; a correction unit that corrects the left target speed and the right target speed, respectively, based on the left correction amount and the right correction amount; and a drive unit that drives the left drive wheel and the right drive wheel, respectively, based on the left target speed and the right target speed corrected by the correction unit.

### FIELD OF THE INVENTION

The present disclosure relates to a self-propelled robot.

### BACKGROUND ART

In recent years, a self-propelled robot that runs autonomously on a floor such as a carpet to clean the floor has been known. Such a self-propelled robot may travel straight while sliding laterally due to influence of pile of a carpet for a straight target trajectory, and thus is required to reduce this.

For example, JP 2015-521760 A discloses a robot device that estimates a carpet drift based on driving characteristics detected by a first sensor set for detecting rotation of a wheel and movement characteristics detected by a second sensor for detecting rotation of a main body.

However, the conventional robot device disclosed in JP 2015-521760 A includes a gyroscope sensor. Thus, skidding cannot be detected unless the main body turns greatly on the carpet, so that further improvement is required.

### SUMMARY OF THE INVENTION

The present disclosure has been made to solve such a problem, and an object of the present disclosure is to provide a self-propelled robot that reduces skidding even when the main body is not turning on the floor.

A self-propelled robot according to an aspect of the present disclosure includes: a main body; a left drive wheel and a right drive wheel that cause the main body to travel on a floor; a force sensor for detecting a lateral force in a wheel axial direction of each of the left drive wheel and the right drive wheel when the main body travels straight; an acquisition unit that acquires left target speed and right target speed, respectively, for the left drive wheel and the right drive wheel; a correction amount calculation unit that calculates a left correction amount and a right correction amount for the left target speed and the right target speed, respectively, based on the corresponding lateral forces detected by the force sensor; a correction unit that corrects the left target speed and the right target speed, respectively, based on the left correction amount and the right correction amount; and a drive unit that drives the left drive wheel and the right drive wheel, respectively, based on the left target speed and the right target speed corrected by the correction unit.

### BRIEF DESCRIPTION OF THE DRAWINGS

FIG. 1 is a diagram illustrating an example of a configuration of a self-propelled robot according to a first embodiment;

FIG. 2 is a diagram illustrating a state where a caster turns with respect to a main body;

FIG. 3 is a block diagram illustrating a control configuration of the self-propelled robot according to the first embodiment;

FIG. 4 is a diagram illustrating details of processing performed by a traveling direction calculation unit;

FIG. 5 is a diagram illustrating a lateral force acting on a self-propelled robot;

FIG. 6 is a graph illustrating characteristics of correction data;

FIG. 7 is a graph illustrating characteristics of correction data;

FIG. 8 is a flowchart illustrating an example of processing of the self-propelled robot according to the first embodiment;

FIG. 9 is a diagram illustrating an example of a configuration of a self-propelled robot according to a second embodiment;

FIG. 10 is a block diagram illustrating a control configuration of the self-propelled robot according to the second embodiment;

FIG. 11 is a diagram illustrating an example of a method for calculating a lateral force in the second embodiment;

FIG. 12 is a graph illustrating characteristics of correction data; and

FIG. 13 is a flowchart illustrating an example of processing of the self-propelled robot according to the second embodiment.

### DESCRIPTION OF EMBODIMENTS

### (History Leading to the Present Disclosure)

For a straight target trajectory, a self-propelled robot may cause skidding, in which the robot travels straight while sliding laterally, depending on pile of a carpet. In this case, the self-propelled robot intends to travel straight along the target trajectory, but cannot reach a target point on the target trajectory because the actual trajectory deviates from the target trajectory. Therefore, it is required to reduce skidding of a self-propelled robot.

Skidding is an operation in which the self-propelled robot travels straight while sliding laterally, so that a turning speed is not always generated. Thus, even if turning speed generated during skidding is detected using a gyroscope sensor as disclosed in JP 2015-521760 A, the skidding cannot be sufficiently reduced.

Then, the present inventors have obtained knowledge that detecting or estimating a lateral force acting on a pair of drive wheels constituting a self-propelled robot enables skidding to be accurately detected, and have conceived the following aspects of the present disclosure described below.

A self-propelled robot according to an aspect of the present disclosure includes: a main body; a left drive wheel and a right drive wheel that cause the main body to travel on a floor; a force sensor for detecting a lateral force in a wheel axial direction of each of the left drive wheel and the right drive wheel when the main body travels straight; an acquisition unit that acquires left target speed and right target speed, respectively, for the left drive wheel and the right drive wheel; a correction amount calculation unit that calculates a left correction amount and a right correction amount for the left target speed and the right target speed, respectively, based on the corresponding lateral forces detected by the force sensor; a correction unit that corrects the left target speed and the right target speed, respectively, based on the left correction amount and the right correction amount; and a drive unit that drives the left drive wheel and the right drive wheel, respectively, based on the left target speed and the right target speed corrected by the correction unit.

According to this configuration, when the main body travels straight, a lateral force in the wheel axial direction of each of the left drive wheel and the right drive wheel, acting on the corresponding one of the left drive wheel and the right drive wheel, is detected. The left correction amount and the right correction amount are calculated based on the corresponding lateral forces detected, and the left target speed and the right target speed are corrected based on the left correction amount and the right correction amount, respectively. Then, the left drive wheel and the right drive wheel are driven, respectively, based on the corrected left target speed and right target speed.

Here, even when the main body is not turning, the lateral force is generated as long as the main body slides laterally. Thus, this configuration can reduce skidding of the main body even when the main body is not turning on a floor.

The above aspect may further include a speed detection unit that detects a left rotation speed and a right rotation speed of the left drive wheel and the right drive wheel, respectively, and a traveling direction calculation unit that calculates a traveling direction of the main body based on the left rotation speed and the right rotation speed, wherein the correction amount calculation unit calculates the left correction amount and the right correction amount only when the traveling direction calculated by the traveling direction calculation unit satisfies a predetermined condition indicating that the main body is traveling straight.

Skidding occurs when the self-propelled robot intends to travel straight, and does not occur when the main body is explicitly turning. According to this configuration, a traveling direction of the main body is calculated based on the left rotation speed and the right rotation speed of the left drive wheel and the right drive wheel, respectively. Then, the left correction amount and the right correction amount are calculated only when the traveling direction satisfies the predetermined condition indicating that the main body is traveling straight. Thus, the left rotation speed and the right rotation speed can be corrected in a situation where skidding is highly likely to occur, so that the skidding can be reliably reduced.

In the above aspect, the force sensor may have at least one axis of a detection direction.

Although skidding can be detected by using an acceleration sensor, the acceleration sensor is expensive and causes increase in cost of a self-propelled robot. This configuration includes a single-axis force sensor that is generally less expensive compared to an acceleration sensor, so that a self-propelled robot can be formed at low cost.

A self-propelled robot according to another aspect of the present disclosure includes: a main body; a left drive wheel and a right drive wheel that cause the main body to travel on a floor; a driven caster turnably provided with respect to the main body; an angle sensor that detects a turning angle of the driven caster with respect to the main body; a state sensor that detects a state of each of the left drive wheel and the right drive wheel; an acquisition unit that acquires a left target speed and a right target speed of the left drive wheel and the right drive wheel, respectively; a disturbance estimation unit that estimates a left disturbance occurring in a rotation direction of the left drive wheel based on a state of the left drive wheel detected by the state sensor, and estimates a right disturbance occurring in a rotation direction of the right drive wheel based on a state of the right drive wheel detected by the state sensor; a lateral force estimation unit that estimates a lateral force in a wheel axial direction of the left drive wheel and the right drive wheel, acting on the left drive wheel and the right drive wheel, based on the turning angle detected by the angle sensor and the left disturbance and the right disturbance estimated by the disturbance estimation unit; a correction amount calculation unit that calculates a left correction amount and a right correction amount for the left target speed and the right target speed, respectively, based on the lateral force estimated by the lateral force estimation unit; a correction unit that corrects the left target speed and the right target speed based on the left correction amount and the right correction amount, respectively; and a drive unit that rotates the left drive wheel and the right drive wheel based on, respectively, the left target speed and the right target speed corrected by the correction unit.

According to this configuration, the left disturbance and the right disturbance each occurring in a rotation direction of the corresponding one of the left drive wheel and the right drive wheel is estimated in amount, based on a state of the corresponding one of the left drive wheel and the right drive wheel detected by the state sensor. Then, a lateral force acting on the left drive wheel and the right drive wheel is estimated based on the turning angle detected by the angle sensor and the left disturbance and the right disturbance estimated by the disturbance estimation unit. Subsequently, the left correction amount and the right correction amount are calculated based on the estimated lateral force, and the left target speed and the right target speed are corrected, respectively, based on the left correction amount and the right correction amount. Then, the left drive wheel and the right drive wheel are driven, respectively, based on the corrected left target speed and right target speed. Here, the lateral force acting on the left drive wheel and the right drive wheel is generated, as long as the main body slides laterally, even when the main body is not turning. Thus, this configuration can reduce skidding of the main body even when the main body is not turning on a floor. In this configuration, since the lateral force is estimated, skidding can be reduced without using a force sensor.

In the above aspect, the drive unit may include a left motor that drives the left drive wheel and a right motor that drives the right drive wheel, and the state sensor may include a current sensor that detects drive current for each of the left motor and the right motor as the state, and an encoder that detects rotation speed of each of the left motor and the right motor as the state.

According to this configuration, the drive current of each of the left motor and the right motor, and the rotation speed of each of the left motor and the right motor, are used as the state, so that the left disturbance and the right disturbance can be accurately acquired.

In the above aspect, the lateral force estimation unit may calculate a difference between the left disturbance and the right disturbance as a traveling disturbance occurring on the self-propelled robot in a direction of the turning angle to estimate the lateral force determined by a component of the traveling disturbance in the wheel axial direction.

According to this configuration, the lateral force can be accurately estimated.

In the above aspect, the correction amount calculation unit may calculate a correction amount only when the main body is traveling straight.

According to this configuration, since the correction amount is calculated only when the main body is traveling straight, skidding can be reduced only in a situation where the skidding is highly likely to occur.

The above aspect may further include a memory storing correction data in which the lateral force, and the left correction amount as well as the right correction amount, are associated with each other so that the left correction amount is increased to more than the right correction amount, as the lateral force in a left direction with respect to a wheel shaft increases, and in which the lateral force, and the right correction amount as well as the left correction amount, are associated with each other so that the right correction amount is increased to more than the left correction amount, as the lateral force in a right direction with respect to the wheel shaft increases, wherein the correction amount calculation unit may calculate the left correction amount and the right correction amount by acquiring the left correction amount and the right correction amount corresponding to the lateral force detected or estimated from the correction data.

According to this configuration, when skidding in the left direction occurs, the left correction amount increases more than the right correction amount as the lateral force in the left direction increases. As a result, a driving force of the left drive wheel increases more than a driving force of the right drive wheel, so that the skidding in the left direction can be reduced. In addition, when skidding in the right direction occurs, the right correction amount increases more than the left correction amount as the lateral force in the right direction increases. As a result, a driving force of the right drive wheel increases more than a driving force of the left drive wheel, so that the skidding in the right direction can be reduced.

The present disclosure can also be realized as a control program that causes a computer to execute each characteristic configuration included in such a self-propelled robot, or as a system that operates based on the control program. Needless to say, such a computer program can be distributed via a non-transitory computer-readable recording medium such as a CD-ROM or a communication network like the Internet.

Each of embodiments described below shows a specific example of the present disclosure. Numerical values, shapes, components, steps, order of steps, and the like shown in the following embodiments are merely examples, and do not intend to limit the present disclosure. In addition, components in the following embodiments include a component that is not described in independent claims indicating the highest concept and that is described as an arbitrary component. Further, in all the embodiments, contents thereof can be combined.

### FIRST EMBODIMENT

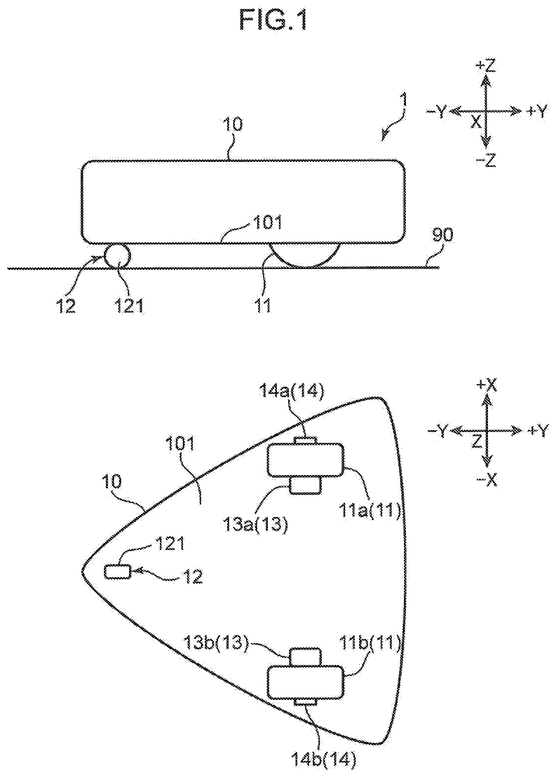

FIG. 1 is a diagram illustrating an example of a configuration of a self-propelled robot 1 according to a first embodiment. Hereinafter, in the present specification, an upward direction of the self-propelled robot 1 is referred to as +Z direction, and a downward direction thereof is referred to as −Z direction. A front direction of the self-propelled robot 1 is referred to as +Y direction, and a direction opposite to the front direction is referred to as −Y direction. A left direction of the self-propelled robot 1 facing the front direction is referred to as +X direction, and a right direction of the self-propelled robot 1 facing the front direction is referred to as −X direction. The self-propelled robot 1, for example, moves autonomously indoors to clean an indoor floor. In FIG. 1, for convenience of explanation, illustration of a suction mechanism is eliminated Z direction is a general term for +Z direction and −Z direction. Y direction is a general term for +Y direction and −Y direction. X direction is a general term for +X direction and -X direction. FIG. 1 includes an upper view that is a view of the self-propelled robot 1 seen in +X direction, and a lower view that is a view of the self-propelled robot 1 seen in −Z direction, i.e., of a main body 10 seen from above.

The self-propelled robot 1 illustrated in FIG. 1 includes a main body 10, drive wheels 11, a caster 12, motors 13, and force sensors 14. The drive wheels 11 include a left-and-right pair of a left drive wheel 11a and a right drive wheel 11b. The motors 13 include a left motor 13a that drives the left drive wheel 11a and a right motor 13b that drives the right drive wheel 11b. The force sensors 14 include a force sensor 14a that detects a lateral force acting on the left drive wheel 11a, and a force sensor 14b that detects a lateral force acting on the right drive wheel 11b.

The left drive wheel 11a and the right drive wheel 11b are each provided partially exposed on a back surface 101 of the main body 10. The left drive wheel 11a and the right drive wheel 11b each include a wheel shaft (not illustrated). The left drive wheel 11a is rotated around the wheel shaft by power from the left motor 13a. The right drive wheel 11b is rotated around the wheel shaft by power from the right motor 13b. The wheel shafts are parallel to each other in X direction. Thus, the main body 10 travels forward when the left drive wheel 11a and the right drive wheel 11b are rotated forward at the same rotation speed. The main body 10 travels backward when the left drive wheel 11a and the right drive wheel 11b are rotated backward at the same rotation speed. The main body 10 turns when the left drive wheel 11a and the right drive wheel 11b are caused to differ in rotation speed. Specifically, when the left drive wheel 11a rotating forward has a rotation speed higher than a rotation speed of the right drive wheel 11b, the main body 10 turns in a right front direction. On the other hand, when the right drive wheel 11b rotating forward has a rotation speed higher than a rotation speed of the left drive wheel 11a, the main body 10 turns in a left front direction. The self-propelled robot 1 can also turn backward.

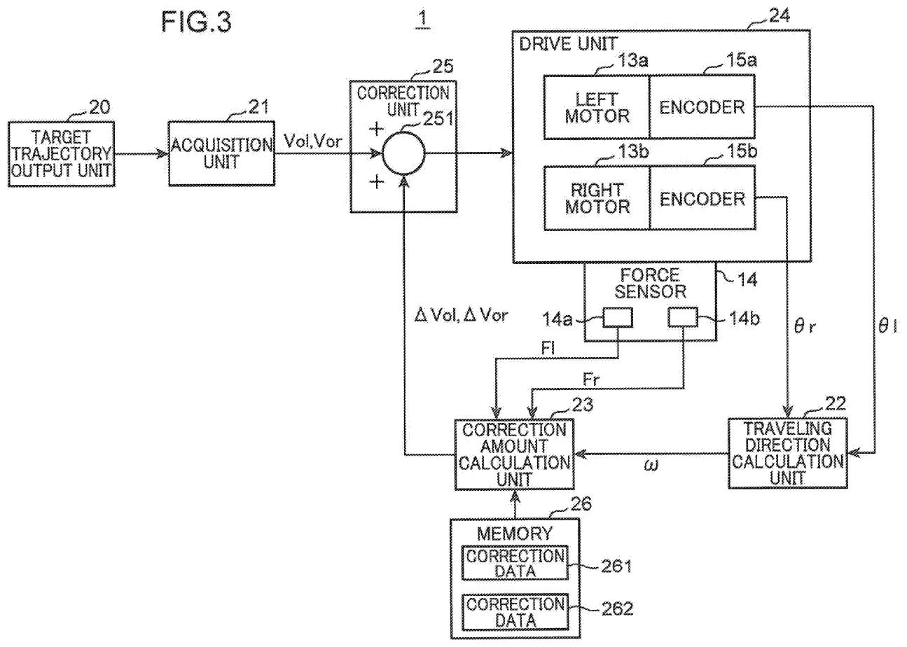

The speed of each of the left motor 13a and the right motor 13b is controlled by a microcontroller (not illustrated) built in the main body 10. The left motor 13a incorporates an encoder 15a (see FIG. 3), and the right motor 13b incorporates an encoder 15b (see FIG. 3). The encoder 15a detects a left rotation speed that is a rotation speed of the left motor 13a. The encoder 15b detects a right rotation speed that is a rotation speed of the right motor 13b. The encoder 15a is an example of a speed detector that detects the left rotation speed of the left drive wheel 11a, and the encoder 15b is an example of a speed detection unit that detects the right rotation speed of the right drive wheel 11b.

The caster 12 serves to prevent the main body 10 from inclining forward and backward, and to keep the back surface 101 of the main body 10 substantially parallel to a floor 90. The caster 12 includes a wheel 121 and a holder (not illustrated) that holds the wheel 121 rotatably. The holder (not illustrated) is mounted on the back surface 101 so as to be turnable about an axis parallel to Z direction. This allows the caster 12 to turn with respect to the main body 10. The wheel 121 of the caster 12 has no driving force and is passively rotated in accordance with moving speed of the main body 10. The holder (not illustrated) of the caster 12 has no driving force and is passively turned in accordance with turning of the main body 10.

The force sensor 14a detects a lateral force generated between the left drive wheel 11a and a wheel shaft (not illustrated) of the left drive wheel 11a in the wheel axial direction. The force sensor 14a is configured by, for example, a single-axis force sensor. The force sensor 14b detects a lateral force generated between the right drive wheel 11b and a wheel shaft (not illustrated) of the right drive wheel 11b in the wheel axial direction. The force sensor 14b is configured by, for example, a single-axis force sensor. Each of the force sensors 14a and 14b can be configured by, for example, a force sensor of a piezoelectric type or a strain gauge type.

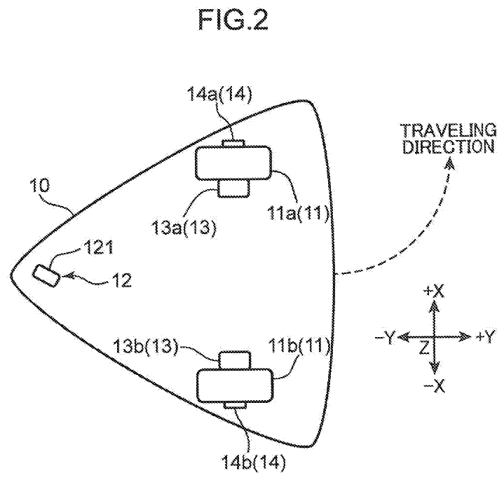

FIG. 2 is a diagram illustrating a state where the caster 12 turns with respect to the main body 10. As illustrated in FIG. 2, the caster 12 can turn with respect to the main body 10. Thus, when a traveling direction of the main body 10 is not Y direction but diagonally forward left or diagonally forward right with respect to Y direction, the wheel 121 can be turned in the traveling direction. As a result, the self-propelled robot 1 can turn without dragging the wheel 121.

FIG. 3 is a block diagram illustrating a control configuration of the self-propelled robot 1 according to the first embodiment. The self-propelled robot 1 includes a target trajectory output unit 20, an acquisition unit 21, a traveling direction calculation unit 22, a correction amount calculation unit 23, a drive unit 24, a correction unit 25, and a memory 26, in addition to the left motor 13a, the right motor 13b, the force sensors 14, the encoder 15a, and the encoder 15b described above. In FIG. 3, the target trajectory output unit 20 to the correction unit 25 are each configured by a microcontroller. The memory 26 is configured by, for example, a nonvolatile semiconductor memory.

The target trajectory output unit 20 outputs target trajectory data indicating a target trajectory of the self-propelled robot 1. The target trajectory data define an operation sequence for causing the self-propelled robot 1 to travel along a target trajectory, the operation sequence including; for example, traveling straight from a point A1 to a point A2 at a target speed V1; then turning at the point A2 with a turning radius r1 at an angular velocity ω1; and then traveling at a target speed V2 from the point A2 to a point A3. The target trajectory data is created in advance, for example, and stored in the memory 26. Thus, the target trajectory output unit 20 may only read out the target trajectory data from the memory 26 and sequentially output the target trajectory data to the acquisition unit 21 in the order of sequence numbers.

The acquisition unit 21 acquires a target speed by acquiring target trajectory data from the target trajectory output unit 20. Then, the acquisition unit 21 calculates a left target speed Vol that is a target speed of the left motor 13a, and a right target speed Vor that is a target speed of the right motor 13b, based on the acquired target trajectory data, and outputs the calculated target speeds to the correction unit 25.

The traveling direction calculation unit 22 calculates the traveling direction of the main body 10 based on a left rotation speed θ1 of the left motor 13a received from the encoder 15a and a right rotation speed θr of the right motor 13b received from the encoder 15b. The left rotation speed θ1 is the amount of rotation of the left motor 13a per second, i.e., an angular velocity. The right rotation speed θr is the amount of rotation of the right motor 13b per second, i.e., an angular velocity.

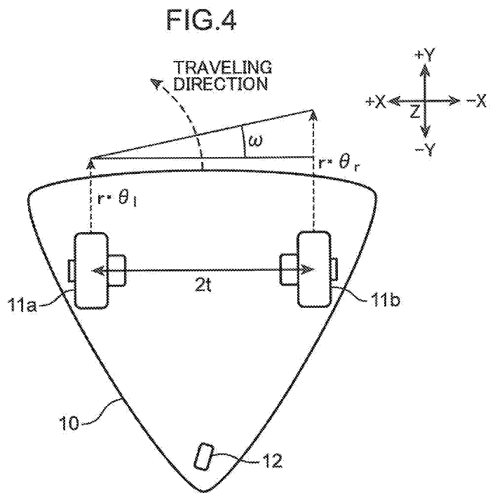

Details of processing of the traveling direction calculation unit 22 will be described below with reference to FIG. 4. FIG. 4 is a diagram illustrating details of the processing performed by the traveling direction calculation unit 22. The left drive wheel 11a and the right drive wheel 11b each have a radius indicated as “r”. In this case, a moving distance of the left drive wheel 11a per second is indicated as r·θ1. Similarly, a moving distance of the right drive wheel 11b per second is indicated as r·θr. When the right rotation speed θr>the left rotation speed θ1, i.e., when the main body 10 turns left, a difference in the moving distance between the left drive wheel 11a and the right drive wheel 11b is indicated as r·(θr−θ1). The left drive wheel 11a and the right drive wheel 11b each have a length in the wheel axial direction (X direction) that is indicated as 2t. In this case, a traveling direction ω of the main body 10 is calculated by Equation (1) below using a trigonometric function. The traveling direction ω is a turning angle of the main body 10 per second around a yaw axis (Z-axis).

ω=tan⁻¹(r·(θr−θ1)/2t (1)

The same applies to when θr<θ1, i.e., when the main body 10 turns right. The traveling direction calculation unit 22 outputs the traveling direction co of the main body 10 calculated using Equation (1) to the correction amount calculation unit 23.

The correction amount calculation unit 23 calculates a left correction amount ΔVol and a right correction amount ΔVor for the left target speed Vol and the right target speed Vor based on the lateral forces Fl and Fr detected by the corresponding force sensors 14, respectively, and outputs the calculated correction amounts to the correction unit 25.

Specifically, the correction amount calculation unit 23 determines whether the traveling direction ω output from the traveling direction calculation unit 22 satisfies a predetermined condition that allows the main body 10 to be considered to be traveling straight, and calculates the left correction amount ΔVol and the right correction amount ΔVor only when determining that the traveling direction ω satisfies the predetermined condition. The predetermined condition is, for example, set such that the traveling direction ω and an angle ϵ set in advance satisfy |ω|≤ϵ. This condition indicates that the traveling direction co is substantially forward or backward, and means that the main body 10 has not turned. When the main body 10 has not turned, the cornering force acting on the self-propelled robot 1 is almost zero, and thus a normal state is without the lateral forces Fl, Fr. However, when traveling on the carpet, the lateral forces Fl, Fr may be generated on the left drive wheel 11a and the right drive wheel 11b, respectively, depending on pile of a carpet. This causes the self-propelled robot 1 to generate skidding in which the robot travels straight while sliding laterally even for a straight target trajectory.

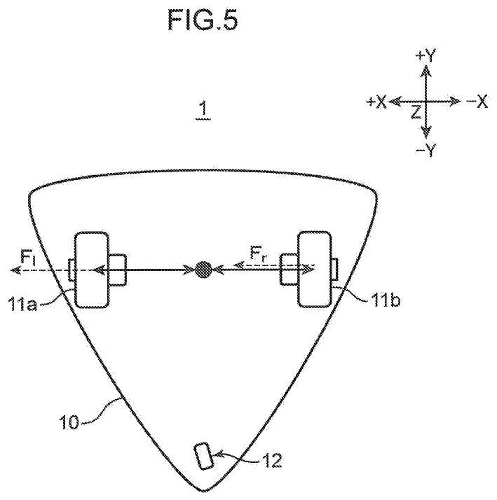

FIG. 5 is a diagram illustrating a lateral force acting on the self-propelled robot 1. As illustrated in FIG. 5, when skidding occurs, the lateral forces Fl, Fr are generated on the left drive wheel 11a and the right drive wheel 11b, respectively. In the example of FIG. 5, since the skidding occurs in +X direction (left direction), the lateral force Fl, Fr in +X direction (left direction) are generated on the left drive wheel 11a and the right drive wheel 11b, respectively. In this case, the respective force sensors 14 detect the lateral forces Fl, Fr that are each equal to or greater than a predetermined value. This enables the correction amount calculation unit 23 to estimate that skidding occurs.

In the present embodiment, the memory 26 stores correction data 261 obtained by a preliminary experiment, indicating a relationship between a lateral force Ft that is the sum of the lateral force Fl and the lateral force Fr, and the left correction amount ΔVol corresponding to the lateral force Ft. The memory 26 also stores correction data 262 obtained by a preliminary experiment, indicating a relationship between the lateral force Ft and the right correction amount ΔVor corresponding to the lateral force Ft. The correction amount calculation unit 23 calculates the lateral force Ft from the lateral force Fl and the lateral force Fr detected by the corresponding force sensors 14, and acquires not only the left correction amount ΔVol corresponding to the lateral force Ft by referring to the correction data 261, but also the right correction amount ΔVor corresponding to the lateral force Ft by referring to the correction data 262.

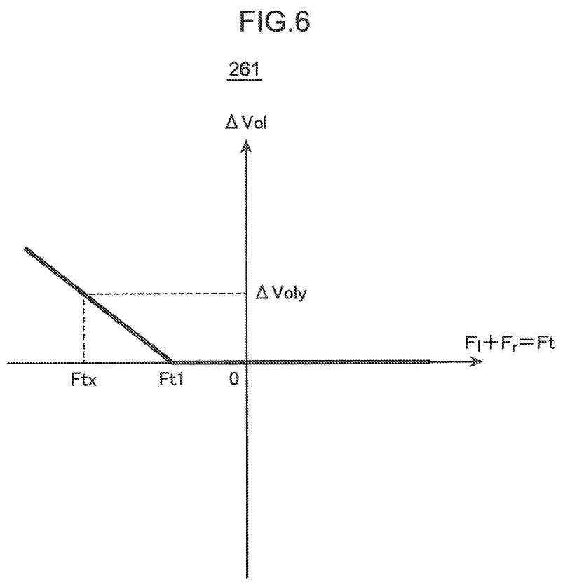

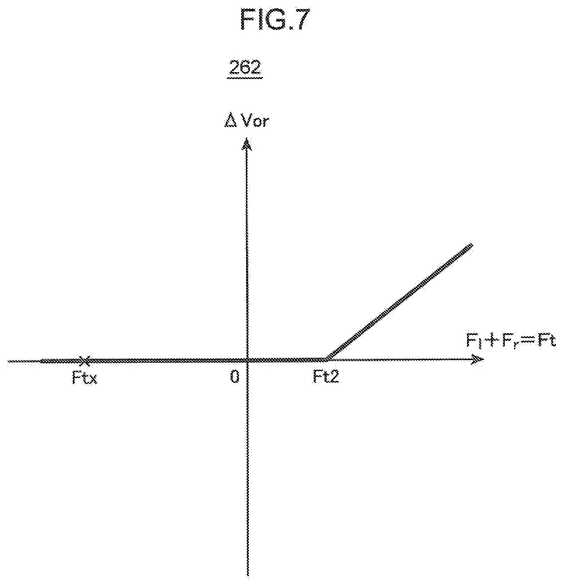

FIG. 6 is a graph illustrating characteristics of the correction data 261. FIG. 7 is a graph illustrating characteristics of the correction data 262. The correction data 261 has the vertical axis representing the left correction amount ΔVol, and the horizontal axis representing the lateral force Ft. In the correction data 261, the horizontal axis is positive when the lateral force Ft is oriented in −X direction (right direction), i.e., when skidding occurs in the right direction, and is negative when the lateral force Ft is oriented in +X direction (left direction), i.e., when skidding occurs in the left direction.

The correction data 261 show that while the left correction amount ΔVol is zero when the lateral force Ft is more than a lateral force Ft1, the left correction amount ΔVol increases linearly, for example, as the lateral force Ft increases in the negative direction when the lateral force Ft is equal to or less than the lateral force Ft1. Here, the left correction amount ΔVol is zero when the lateral force Ft is more than zero because no skidding has occurred in the left direction and correction of the left target speed Vol is not required. When the lateral force Ft is more than the lateral force Ft1 and equal to or less than zero, a dead zone where the left correction amount ΔVol is zero is provided. This is because the lateral force Ft is considered to be too small to cause skidding. When the lateral force Ft is equal to or less than the lateral force Ft1, the left correction amount ΔVol linearly increases as the lateral force Ft increases in the negative direction. This is because, in order to reduce skidding in the left direction, the left correction amount ΔVol to be added to the left target speed Vol needs to be increased as the lateral force Ft acting in the left direction increases.

The correction data 262 has the vertical axis representing the right correction amount ΔVor, and the horizontal axis representing the lateral force Ft. In the correction data 262, the horizontal axis is positive when the lateral force Ft is oriented in −X direction (right direction), i.e., when skidding occurs in the right direction, and is negative when the lateral force Ft is oriented in +X direction (left direction), i.e., when skidding occurs in the left direction.

The correction data 262 shows that while the right correction amount ΔVor is zero when the lateral force Ft is equal to or less than a lateral force Ft2, the right correction amount ΔVor increases linearly, for example, as the lateral force Ft increases in the positive direction when the lateral force Ft is more than the lateral force Ft2. Here, the right correction amount ΔVor is zero when the lateral force Ft is equal to or less than zero because no skidding has occurred in the right direction and correction of the right target speed Vor is not required. When the lateral force Ft is more than zero and less than the lateral force Ft2, a dead zone where the right correction amount ΔVor is zero is provided. This is because the lateral force Ft is considered to be too small to cause skidding. When the lateral force Ft is more than the lateral force Ft2, the right correction amount ΔVor linearly increases as the lateral force Ft increases in the positive direction. This is because the right correction amount ΔVor to be added to the right target speed Vor is increased as the lateral force Ft acting in the right direction increases, thereby reducing skidding in the right direction. In the examples of FIGS. 6 and 7, the lateral force Ft1 and the lateral force Ft2 have different values in the positive and negative directions, but each have the same absolute value.

For example, when the lateral force Ft detected by the force sensor 14 has a value Ftx, the correction amount calculation unit 23 refers to the correction data 261 to acquire the left correction amount ΔVol (=ΔVoly) corresponding to the value Ftx, and refers to the correction data 262 to acquire the right correction amount ΔVor (=0) corresponding to the value Ftx. Then, the correction amount calculation unit 23 outputs the acquired left correction amount ΔVol (=ΔVoly) and right correction amount ΔVor (=0) to the correction unit 25. Thus, when skidding in the left direction occurs, the left correction amount ΔVol (=ΔVoly) is added to the left target speed Vol, and the right correction amount ΔVor (=0) is added to the right target speed Vor. This causes the left target speed Vol to be increased to more than the right target speed Vor. As a result, the driving force of the left drive wheel 11a is increased to more than the driving force of the right drive wheel 11b, so that skidding of the main body 10 in the left direction is reduced.

Refer back to FIG. 3. The correction unit 25 corrects the left target speed Vol and the right target speed Vor based on the left correction amount ΔVol and the right correction amount ΔVor, respectively. The correction unit 25 includes an adder 251. The adder 251 corrects the left target speed Vol by adding the left correction amount ΔVol output from the correction amount calculation unit 23 to the left target speed Vol output from the acquisition unit 21. The adder 251 corrects the right target speed Vor by adding the right correction amount ΔVor output from the correction amount calculation unit 23 to the right target speed Vor output from the acquisition unit 21.

The drive unit 24 drives the left drive wheel 11a and the right drive wheel 11b based on, respectively, the left target speed Vol and the right target speed Vor, corrected by the correction unit 25. The drive unit 24 includes the left motor 13a, the right motor 13b, the encoder 15a, and the encoder 15b, described in FIG. 1. The left target speed Vol corrected by the correction unit 25 is input to the left motor 13a. This causes the left motor 13a to rotate at the left target speed Vol. The right target speed Vor corrected by the correction unit 25 is input to the right motor 13b. This causes the right motor 13b to rotate at the right target speed Vor.

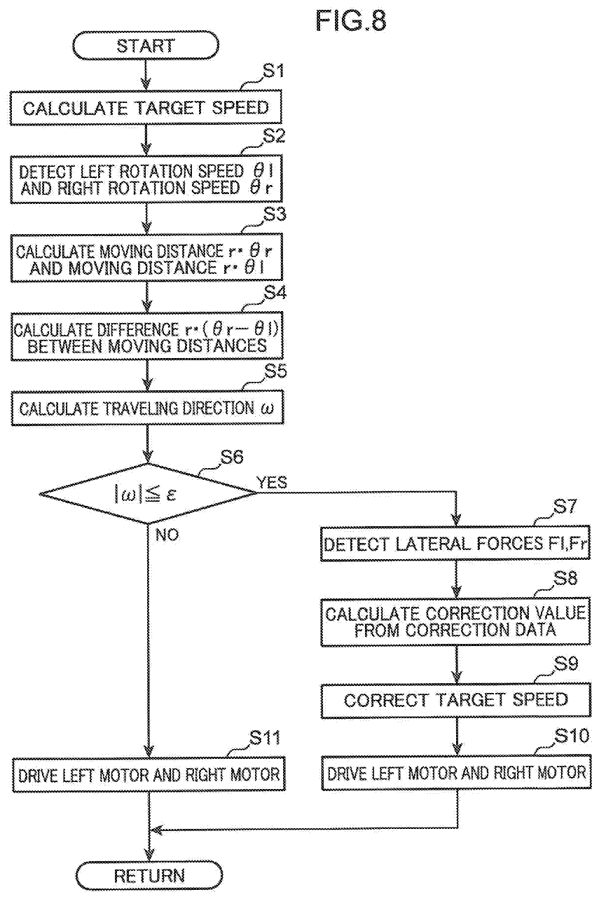

FIG. 8 is a flowchart illustrating an example of processing of the self-propelled robot 1 according to the first embodiment. The flow of FIG. 8 is repeatedly executed, for example, at a predetermined calculation interval. In step S1, the acquisition unit 21 calculates the left target speed Vol and the right target speed Vor from the target trajectory data acquired from the target trajectory output unit 20.

In step S2, the encoder 15a detects the left rotation speed θ1, and the encoder 15b detects the right rotation speed θr.

In step S3, the traveling direction calculation unit 22 calculates the moving distance r·θ1 of the left drive wheel 11a and the moving distance r·θr of the right drive wheel 11b.

In step S4, the traveling direction calculation unit 22 calculates a difference r·(θr−θ1) between the moving distance r·θ1 and the moving distance r·θr.

In step S5, the traveling direction calculation unit 22 calculates the traveling direction ω by substituting r·(θr−θ1) into Equation (1).

In step S6, the correction amount calculation unit 23 determines whether the traveling direction ω is equal to or less than the angle ϵ. When the traveling direction ω is equal to or less than the angle ϵ (YES in step S6), the force sensor 14a detects the lateral force Fl, and the force sensor 14b detects the lateral force Fr (step S7).

In step S8, the correction amount calculation unit 23 calculates the lateral force Ft by adding the lateral force Fl to the lateral force Fr, and calculates not only the left correction amount ΔVol corresponding to the lateral force Ft with reference to the correction data 261, but also the right correction amount ΔVor corresponding to the lateral force Ft with reference to the correction data 262.

In step S9, the correction unit 25 corrects not only the left target speed Vol by adding the left correction amount ΔVol to the left target speed Vol, but also the right target speed Vor by adding the right correction amount ΔVor to the right target speed Vor.

In step S10, the drive unit 24 drives not only the left motor 13a at the corrected left target speed Vol but also the right motor 13b at the corrected right target speed Vor. When step S10 ends, the processing returns to step S1.

In step S6, when the traveling direction co is larger than the angle ϵ (NO in step S6), the drive unit 24 drives the left motor 13a and the right motor 13b, respectively, at the left target speed Vol and the right target speed Vor, calculated in step S1 (step S11). When step S11 ends, the processing returns to step S1.

As described above, according to the present embodiment, when the main body 10 travels straight, the lateral force Ft acting on the left drive wheel 11a and the right drive wheel 11b is detected. The left correction amount ΔVol and the right correction amount ΔVor are calculated based on the lateral force Ft detected, and the left target speed Vol and the right target speed Vor are corrected, respectively, based on the left correction amount ΔVol and the right correction amount ΔVor. Then, the left drive wheel 11a and the right drive wheel 11b are driven, respectively, based on the corrected left target speed Vol and right target speed Vor.

Here, the lateral force Ft acting on the left drive wheel 11a and the right drive wheel 11b is generated, as long as the main body 10 slides laterally, even when the main body 10 is not turning. Thus, this configuration can reduce skidding of the main body 10 even when the main body 10 is not turning on the floor.

In the first embodiment, the lateral forces Fl, Fr are directly detected, and the left target speed Vol and the right target speed Vor are corrected. This enables the left target speed Vol and the right target speed Vor to be corrected before the self-propelled robot 1 actually starts to slide in a direction different from its traveling direction, so that straight traveling operation along the traveling direction can be maintained.

In addition, in the first embodiment, the left target speed Vol and the right target speed Vor are corrected based on the lateral force Ft acting on the left drive wheel 11a and the right drive wheel 11b. Thus, the straight traveling operation along the traveling direction of the main body 10 can be maintained regardless of whether the lateral force Ft acting on the main body 10 is caused by turning of the main body 10 or skidding of the main body 10.

### SECOND EMBODIMENT

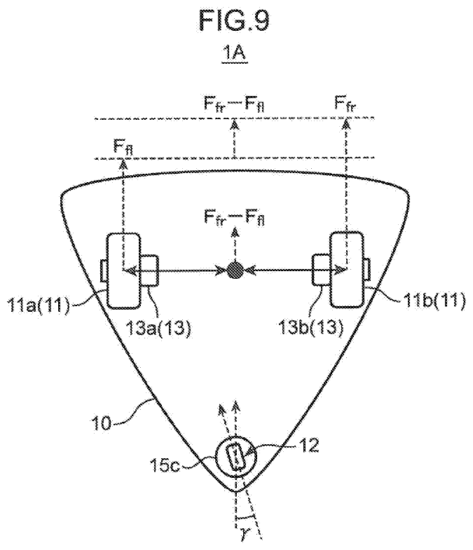

A self-propelled robot 1A according to a second embodiment is configured to estimate lateral forces Fl and Fr. FIG. 9 is a diagram illustrating an example of a configuration of the self-propelled robot 1A according to the second embodiment. In the present embodiment, the same components as those in the first embodiment are denoted by the same reference numerals, and duplicated description thereof will be eliminated. The self-propelled robot 1A further includes an encoder 15c with respect to the self-propelled robot 1. The encoder 15c is attached to the caster 12. The encoder 15c is an example of an angle sensor that detects a turning angle γ of the caster 12 with respect to a main body 10. The turning angle γ is a rotation angle of the caster 12 around Z-axis (yaw axis).

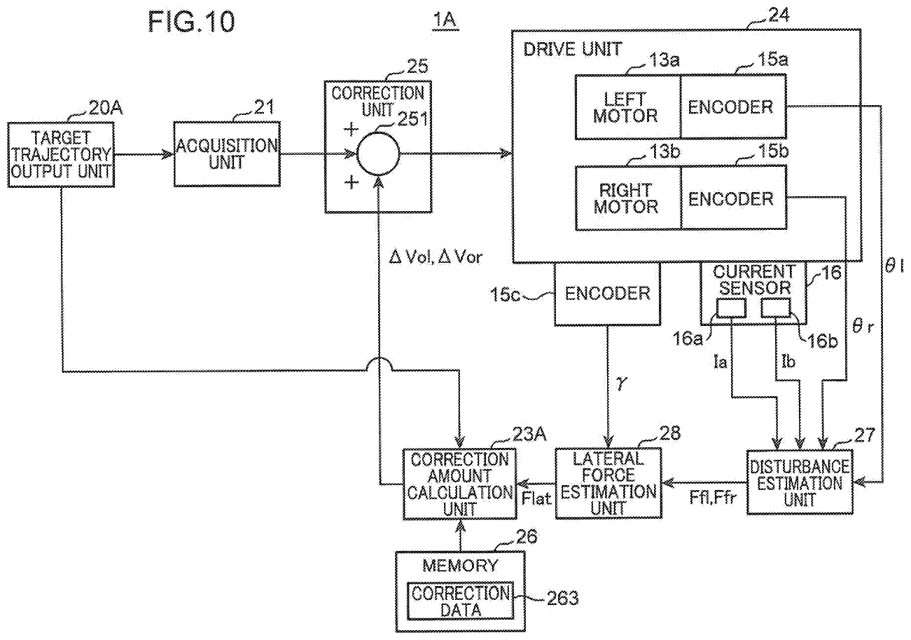

FIG. 10 is a block diagram illustrating a control configuration of the self-propelled robot 1A according to the second embodiment. The self-propelled robot 1A includes a current sensor 16 instead of the force sensor 14 of the self-propelled robot 1. The current sensor 16 includes current sensors 16a, 16b. The current sensor 16a is provided, for example, in a left motor 13a. The current sensor 16b is provided, for example, in a right motor 13b. The current sensor 16a detects a current value Ia of a drive current of the left motor 13a and outputs the detected current value to a disturbance estimation unit 27. The current sensor 16b detects a current value Ib of a drive current of the right motor 13b and outputs the detected current value to the disturbance estimation unit 27.

In the present embodiment, the current sensor 16 and encoders 15a, 15b are each an example of a state sensor that detects a state of corresponding one of a left drive wheel 11a and a right drive wheel 11b.

The self-propelled robot 1A includes a disturbance estimation unit 27 and a lateral force estimation unit 28 instead of the traveling direction calculation unit 22 with respect to the self-propelled robot 1. In FIG. 10, blocks with the same names having different functions from those of the first embodiment are denoted by the same reference numerals with A attached to their ends.

The disturbance estimation unit 27 estimates a left load disturbance T1 occurring in the left motor 13a based on the current value Ia detected by the current sensor 16a and a left rotation speed θ1 detected by the encoder 15a. The disturbance estimation unit 27 estimates a right load disturbance Tr occurring in the right motor 13b based on the current value Ib detected by the current sensor 16b and a right rotation speed Or detected by the encoder 15b. Here, the disturbance estimation unit 27 may estimate the left load disturbance T1 and the right load disturbance Tr using, for example, a disturbance observer. The left load disturbance T1 and the right load disturbance Tr occurring in the left motor 13a and the right motor 13b, respectively, are disturbances in torque in rotation directions of the left motor 13a and the right motor 13b, respectively. Thus, when the left drive wheel 11a and the right drive wheel 11b each have a radius indicated as r, the left disturbance Ffl occurring in the rotation direction of the left drive wheel 11a is calculated as r·T1, and the right disturbance Ffr occurring in the rotation direction of the right drive wheel 11b is calculated as r·Tr. Then, the disturbance estimation unit 27 calculates the left disturbance Ffl as r·T1, and calculates the right disturbance Ffr as r·Tr.

The lateral force estimation unit 28 estimates a lateral force Flat in the wheel axial direction, acting on the left drive wheel 11a and the right drive wheel 11b, based on the left disturbance Ffl and the right disturbance Ffr output from the disturbance estimation unit 27, and the turning angle γ of the caster 12 output from the encoder 15c.

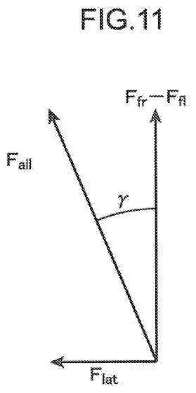

FIG. 11 is a diagram illustrating an example of a method for calculating the lateral force Flat in the second embodiment. In this example, the left disturbance Ffl occurring in the left drive wheel 11a and the right disturbance Ffr occurring in the right drive wheel 11b have a difference therebetween that is considered as disturbance in traveling (traveling disturbance), and an equal portion that is considered to correspond to a driving force. Thus, first, the lateral force estimation unit 28 calculates the traveling disturbance as Ffr−Ffl. The turning angle γ output from the encoder 15c is considered to be close to a direction of the traveling disturbance occurring in the self-propelled robot 1A. That is, traveling disturbance Fall can be considered to occur in a direction with the turning angle γ. Then, the lateral force estimation unit 28 estimates the traveling disturbance Fall using Equation (2).

Fall=k·((Ffr−FM/cosγ) (2)
where k is an adjustment coefficient determined in a preliminary experiment.

Here, the traveling disturbance Fall occurring in the self-propelled robot 1A includes a component corresponding to the wheel axial direction that can be regarded as the lateral force Flat. Thus, the lateral force Flat is expressed by Equation (3) using a trigonometric function.

Flat=Fall·sinγ (3)
Thus, the lateral force estimation unit 28 estimates the lateral force Flat as Flat·sinγ.

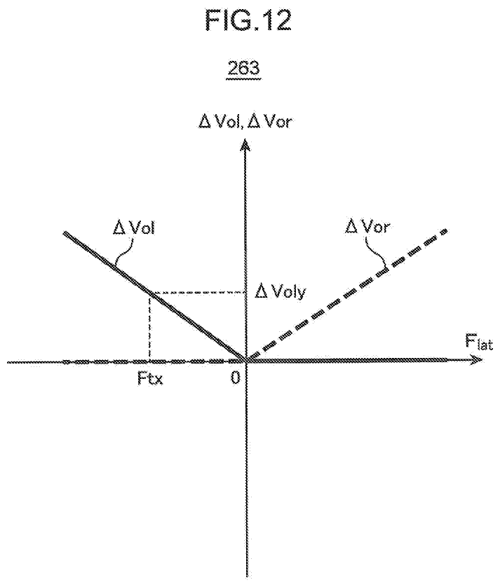

The correction amount calculation unit 23A calculates a left correction amount ΔVol and a right correction amount ΔVor based on the lateral force Flat estimated by the lateral force estimation unit 28. Specifically, the correction amount calculation unit 23A calculates the left correction amount ΔVol and the right correction amount ΔVor with reference to correction data 263 illustrated in FIG. 12, and outputs the calculated correction amounts to a correction unit 25. FIG. 12 is a graph illustrating characteristics of the correction data 263. The correction data 263 has the vertical axis representing the left correction amount ΔVol and the right correction amount ΔVor, and the horizontal axis representing the lateral force Flat. In the correction data 263, the horizontal axis is positive when the lateral force Flat is oriented in −X direction (right direction), i.e., when skidding occurs in the right direction, and is negative when the lateral force Flat is oriented in +X direction (left direction), i.e., when skidding occurs in the left direction.

In FIG. 12, the left correction amount ΔVol indicated by a solid line is zero when the lateral force Flat is more than zero. This is because, when the lateral force Flat is more than zero, no skidding occurs in the left direction, and correction of a left target speed Vol is not required. When the lateral force Flat is equal to or less than zero, the left correction amount ΔVol increases, for example, linearly as the lateral force Flat increases in the negative direction. This is because, in order to reduce the skidding in the left direction, the left correction amount ΔVol to be added to the left target speed Vol needs to be increased as the lateral force Flat acting in the left direction increases.

In FIG. 12, the right correction amount ΔVor indicated by a dotted line is zero when the lateral force Flat is equal to or less than zero. This is because, when the lateral force Flat is equal to or less than zero, no skidding occurs in the right direction and correction of a right target speed Vor is not required. When the lateral force Flat is more than zero, the right correction amount ΔVor increases, for example, linearly as the lateral force Flat increases in the positive direction. This is because, in order to reduce the skidding in the right direction, the right correction amount Vor to be added to the right target speed Vor needs to be increased as the lateral force Flat acting in the right direction increases.

Unlike FIGS. 6 and 7, no dead zone is illustrated in FIG. 12. This is because, in the present embodiment, the left correction amount ΔVol and the right correction amount ΔVor are calculated under conditions where the caster 12 turns with respect to the main body 10, as shown in Equation (3). That is, this is because, the caster 12 turning with respect to the main body 10 is considered to have the lateral force Flat enough to cause skidding.

For example, when the lateral force Flat detected by the force sensor 14 has a value Ftx, the correction amount calculation unit 23A refers to the correction data 263 to acquire not only the left correction amount ΔVol (=ΔVoly) corresponding to the value Ftx, but also the right correction amount ΔVor (=0) corresponding to the value Ftx, and outputs the acquired correction amounts to the correction unit 25. Thus, when skidding in the left direction occurs, the left correction amount ΔVol (=ΔVoly) is added to the left target speed Vol, and the right correction amount ΔVor (=0) is added to the right target speed Vor. This causes the left target speed Vol to be increased to more than the right target speed Vor. As a result, the driving force of the left drive wheel 11a is increased to more than the driving force of the right drive wheel 11b, so that skidding of the main body 10 in the left direction is reduced.

Refer back to FIG. 10. In the present embodiment, a target trajectory output unit 20A outputs not only target trajectory data on the self-propelled robot 1A to an acquisition unit 21, but also a straight-traveling notification signal indicating whether the self-propelled robot 1 is traveling straight, acquired from the target trajectory data, to the correction amount calculation unit 23A. Influence of response time or the like of each of the left motor 13a and the right motor 13b causes a delay from when the target trajectory data is output to the acquisition unit 21 to when the self-propelled robot 1A actually starts operating according to the target trajectory data. Then, the target trajectory output unit 20A may set a delay time (e.g., one second) in advance to output the straight-traveling notification signal to the correction amount calculation unit 23A at a point in time when the delay time elapses from the time when the target trajectory data indicating the straight traveling is output to the acquisition unit 21. In this case, the correction amount calculation unit 23A may start correction processing of the left target speed Vol and the right target speed Vor after receiving the straight-traveling notification signal. This enables the correction amount calculation unit 23A to perform the correction processing only when the target trajectory data indicates that the vehicle is traveling straight.

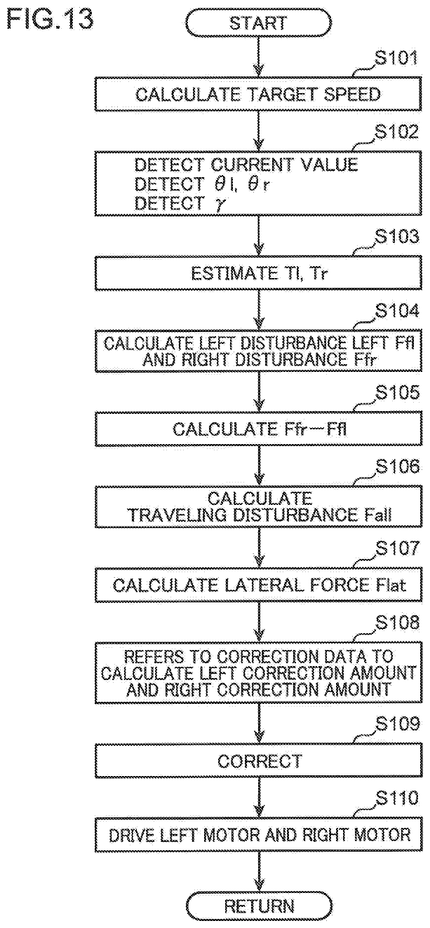

FIG. 13 is a flowchart illustrating an example of processing of the self-propelled robot 1A according to the second embodiment. The flow of FIG. 13 is repeatedly executed, for example, at a predetermined calculation interval. In step S101, the acquisition unit 21 calculates the left target speed Vol and the right target speed Vor from the target trajectory data acquired from the target trajectory output unit 20.

In step S102, the current sensor 16a detects the current value Ia of the left motor 13a, and the current sensor 16b detects the current value Ib of the right motor 13b. In step S102, the encoder 15a detects the left rotation speed θ1 of the left motor 13a, and the encoder 15b detects the right rotation speed θr of the right motor 13b. In step S2, the encoder 15c detects the turning angle γ of the caster 12.

In step S103, the disturbance estimation unit 27 estimates not only the left load disturbance T1 based on the current value Ia and the left rotation speed θ1, but also the right load disturbance Tr based on the current value Ib and the right rotation speed θr.

In step S104, the disturbance estimation unit 27 calculates not only the left disturbance Ffl as r·T1, but also the right disturbance Ffr as r·Tr.

In step S105, the lateral force estimation unit 28 calculates a difference (=Ffr−Ffl) between the left disturbance Ffl and the right disturbance Ffr.

In step S106, the lateral force estimation unit 28 substitutes the difference (=Ffr−Ffl) between the left disturbance Ffl and the right disturbance Ffr, and the turning angle γ into Equation (2) to calculate the traveling disturbance Fall.

In step S107, the lateral force estimation unit 28 substitutes the traveling disturbance Fall and the turning angle γ into Equation (3) to calculate the lateral force Flat.

In step S108, the correction amount calculation unit 23A refers to the correction data 263 to calculate the left correction amount ΔVol and the right correction amount ΔVor for the estimated lateral force Flat.

Processing in steps S109 and S110 is the same as that in steps S9 and S10 illustrated in FIG. 8.

As described above, according to the second embodiment, the correction amount calculation unit 23A calculates the left correction amount ΔVol and the right correction amount Vor based on the lateral force Flat estimated by the lateral force estimation unit 28, and the left target speed Vol and the right target speed Vor are corrected, respectively, based on the left correction amount ΔVol and the right correction amount ΔVor. This enables the self-propelled robot 1A to achieve straight traveling operation without skidding for a straight target trajectory even in an environment with disturbance such as a carpet.

Here, the meaning of estimating the lateral force Flat acting on the left drive wheel 11a and the right drive wheel 11b using the traveling disturbance Fall and the turning angle γ of the caster 12 (driven caster) will be described. For example, when skidding or turning occurring in the drive wheels 11 due to influence of a carpet is not corrected and the same speed command is continuously given to the right and left drive wheels 11 to intend straight traveling, the right and left drive wheels 11 may have little difference in speed due to influence of a carpet. That is, skidding or turning caused by the carpet may be difficult to be detected based on only a speed difference between the right and left drive wheels 11. On the other hand, the present embodiment enables skidding or turning occurring in the drive wheels 11 due to influence of a carpet to be detected by using the traveling disturbance Fall. In particular, the present embodiment uses the knowledge that when the same speed command is continuously given to the right and left drive wheels 11 to intend straight traveling without correcting the left disturbance Ffl based on the current value 1a and the left rotation speed θ1, and the right disturbance Ffr based on the current value 1b and the right rotation speed θr, even with skidding or turning occurring in the drive wheels 11 due to influence of a carpet, a difference between the left disturbance Ffl and the right disturbance Ffr appears. On the other hand, the traveling disturbance Fall is applied in a rotation direction of each of the right and left drive wheels 11, and is perpendicular to a force causing skidding on a floor. Thus, the present embodiment enables improvement in detection accuracy of influence of a carpet and achieves straight traveling operation by using the turning angle γ of the caster 12 (driven caster) that affects a force in a direction causing skidding along with the traveling disturbance Fall.

In addition, according to the second embodiment, since the lateral force Flat is estimated, the self-propelled robot 1A can be caused to perform the straight traveling operation without skidding, without using a sensor for estimating the lateral force Flat.

Further, according to the second embodiment, the left target speed Vol and the right target speed Vor are corrected based on the lateral force Flat acting on the left drive wheel 11a and the right drive wheel 11b. Thus, the straight traveling operation of the main body 10 can be maintained regardless of whether the lateral force Ft acting on the main body 10 is caused by turning of the main body 10 or skidding of the main body 10.

The present embodiment can employ the following modifications.

(1) While in the second embodiment, the target trajectory output unit 20A outputs a traveling notification signal to the correction amount calculation unit 23A, this is an example, and the target trajectory output unit 20A may not output the traveling notification signal.

(2) While in the first embodiment, the memory 26 includes the correction data 261 and the correction data 262, this is an example, and the memory 26 may store correction data in which the correction data 261 and the correction data 262 are aggregated. In this case, the memory 26 may store correction data in which the lateral force Ft, and the left correction amount ΔVol as well as the right correction amount ΔVor, are associated with each other so that the left correction amount ΔVol is increased to more than the right correction amount ΔVor, as the lateral force Ft in the left direction of the wheel shaft increases, and in which the lateral force Ft, and the right correction amount ΔVor as well as the left correction amount ΔVol, are associated with each other so that the right correction amount ΔVor is increased to more than the left correction amount ΔVol, as the right lateral force Ft of the wheel axis increases.

(3) While the correction data 261 and the correction data 262 each have a dead zone, the present disclosure is not limited to this, and may not have the dead zone.

(4) While in the first embodiment, the two force sensors 14a, 14b are used, this is an example, and the self-propelled robot 1 may include any one of the force sensors 14a, 14b. In this case, the correction amount calculation unit 23 may calculate the lateral force Ft by doubling a lateral force detected by one force sensor. Alternatively, the correction data 261, 262 each may be configured by correction data in which the lateral force detected by one force sensor is associated with the left correction amount ΔVol and the right correction amount ΔVor.

### INDUSTRIAL APPLICABILITY

According to the present disclosure, a self-propelled robot can be caused to travel along a target trajectory while reducing skidding, and thus the present disclosure is useful for a self-propelled robot such as a cleaning robot.

This application is based on Japanese Patent application No. 2019-151532 filed in Japan Patent Office on Aug. 21, 2019, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A self-propelled robot comprising:
a main body;
a left drive wheel and a right drive wheel that cause the main body to travel on a floor;
a force sensor for detecting a lateral force in a wheel axial direction of each of the left drive wheel and the right drive wheel when the main body travels straight;
an acquisition unit that acquires left target speed and right target speed, respectively, for the left drive wheel and the right drive wheel;
a correction amount calculation unit that calculates a left correction amount and a right correction amount for the left target speed and the right target speed, respectively, based on the corresponding lateral forces detected by the force sensor;
a correction unit that corrects the left target speed and the right target speed, respectively, based on the left correction amount and the right correction amount; and
a drive unit that drives the left drive wheel and the right drive wheel, respectively, based on the left target speed and the right target speed corrected by the correction unit.

2. The self-propelled robot according to claim 1, further comprising:
a speed detection unit that detects a left rotation speed and a right rotation speed of the left drive wheel and the right drive wheel, respectively; and
a traveling direction calculation unit that calculates a traveling direction of the main body based on the left rotation speed and the right rotation speed,
wherein the correction amount calculation unit calculates the left correction amount and the right correction amount only when the traveling direction calculated by the traveling direction calculation unit satisfies a predetermined condition indicating that the main body is traveling straight.

3. The self-propelled robot according to claim 1, wherein the force sensor has at least one axis of a detection direction.

4. The self-propelled robot according to claim 1, wherein the correction amount calculation unit calculates the correction amount only when the main body is traveling straight.

5. The self-propelled robot according to claim 1, further comprising:
a memory storing correction data in which the lateral force, and the left correction amount as well as the right correction amount, are associated with each other so that the left correction amount is increased more than the right correction amount, as the lateral force in a left direction with respect to a wheel shaft increases, and in which the lateral force, and the right correction amount as well as the left correction amount, are associated with each other so that the right correction amount is increased to more than the left correction amount, as the lateral force in a right direction with respect to the wheel shaft increases,
wherein the correction amount calculation unit calculates the left correction amount and the right correction amount by acquiring the left correction amount and the right correction amount corresponding to the lateral force detected from the correction data.

6. A self-propelled robot comprising:
a main body;
a left drive wheel and a right drive wheel that cause the main body to travel on a floor;
a driven caster turnably provided with respect to the main body;
an angle sensor that detects a turning angle of the driven caster with respect to the main body;
a state sensor that detects a state of each of the left drive wheel and the right drive wheel;
an acquisition unit that acquires a left target speed and a right target speed of the left drive wheel and the right drive wheel, respectively;
a disturbance estimation unit that estimates a left disturbance occurring in a rotation direction of the left drive wheel based on a state of the left drive wheel detected by the state sensor, and estimates a right disturbance occurring in a rotation direction of the right drive wheel based on a state of the right drive wheel detected by the state sensor;
a lateral force estimation unit that estimates a lateral force in a wheel axial direction of the left drive wheel and the right drive wheel, acting on the left drive wheel and the right drive wheel, based on the turning angle detected by the angle sensor and the left disturbance and the right disturbance estimated by the disturbance estimation unit;
a correction amount calculation unit that calculates a left correction amount and a right correction amount for the left target speed and the right target speed, respectively, based on the lateral force estimated by the lateral force estimation unit;
a correction unit that corrects the left target speed and the right target speed based on the left correction amount and the right correction amount, respectively; and
a drive unit that rotates the left drive wheel and the right drive wheel based on, respectively, the left target speed and the right target speed corrected by the correction unit.

7. The self-propelled robot according to claim 6, wherein
the drive unit includes a left motor that drives the left drive wheel and a right motor that drives the right drive wheel, and
the state sensor includes a current sensor that detects drive current for each of the left motor and the right motor as the state, and an encoder that detects rotation speed of each of the left motor and the right motor as the state.

8. The self-propelled robot according to claim 6, wherein
the lateral force estimation unit calculates a difference between the left disturbance and the right disturbance as a traveling disturbance occurring on the self-propelled robot in a direction of the turning angle to estimate the lateral force determined by a component of the traveling disturbance in the wheel axial direction.

9. The self-propelled robot according to claim 6, wherein the correction amount calculation unit calculates the correction amount only when the main body is traveling straight.

10. The self-propelled robot according to claim 6, further comprising:
a memory storing correction data in which the lateral force, and the left correction amount as well as the right correction amount, are associated with each other so that the left correction amount is increased to more than the right correction amount, as the lateral force in a left direction with respect to a wheel shaft increases, and in which the lateral force, and the right correction amount as well as the left correction amount, are associated with each other so that the right correction amount is increased to more than the left correction amount, as the lateral force in a right direction with respect to the wheel shaft increases,
wherein the correction amount calculation unit calculates the left correction amount and the right correction amount by acquiring the left correction amount and the right correction amount corresponding to the lateral force estimated from the correction data.
